(19) United States
(12) Patent Application Publication
(10) Pub. No.: US 2026/0022796 A1
(43) Pub. Date: Jan. 22, 2026

(54) MOBILE TERMINAL STAND

(71) Applicant: Shenzhen Sodi Innovation Technologies Co., Ltd, Shenzhen (CN)

(72) Inventors: Yuelian LIU, Shenzhen (CN); Yinsheng YE, Shenzhen (CN); Jie LIU, Shenzhen (CN)

(21) Appl. No.: 18/800,010

(22) Filed: Aug. 10, 2024

(30) Foreign Application Priority Data
Jul. 16, 2024 (CN) 202421684649.5

(51) Int. Cl. F16M 11/20; F16M 11/10; F16M 11/38

(52) U.S. Cl. CPC F16M 11/2064; F16M 11/10; F16M 11/38; F16M 2200/025; F16M 2200/08

(57) ABSTRACT

A mobile terminal stand includes a supporting base, a first supporting member, a second supporting member, and a propping component. The supporting base includes a first bottom member and a second bottom member rotatably connected to the first bottom member. The propping component includes a first propping member and a second propping member rotatably connected to the first propping member. Two ends of the first supporting member are respectively rotatably connected to the first bottom member and the second supporting member, and the second supporting member is rotatably connected to the first propping member. The first bottom member, the second bottom member, the first propping member, and the second propping member are all in a long strip shape. The first bottom member and the second bottom member are brought together at both ends in a storage state and unfolded in a use state.

### CROSS-REFERENCE TO RELATED APPLICATIONS

The application claims priority of Chinese patent application CN2024216846495, filed on Jul. 16, 2024, which is incorporated herein by reference in its entireties.

### TECHNICAL FIELD

The present invention relates to the technical field of computer related products, particularly to a mobile terminal stand.

### BACKGROUND ART

A computer stand is used for supporting a laptop so that the laptop can be obliquely placed and be used in a comfortable way. According to the ergonomics, with the involvement of human-machine design concepts, the computer stand achieves a comfortable laptop user experience. In order to facilitate the easy storage and carrying of computer stands, foldable computer stands have appeared on the market. However, currently, existing computer stands placed on a desktop generally include a base, a propping component, and an inclined supporting member used to support the propping component to incline. By adjusting the position of a bottom end of the inclined supporting member on the base, the inclination angle of the propping component can be adjusted. However, this structure cannot adjust the height at which the laptop is placed, and when the laptop is placed on the propping component, it is inconvenient to adjust the relative position between the bottom end of the inclined supporting member and the base, which is inconvenient for users to use.

### SUMMARY

The main purpose of the present invention is to provide a mobile terminal stand for solving the problems of existing computer stands being unable to adjust a height of the computer and inconvenient to adjust a tilt angle when the computer is placed.

In order to solve the above technical problems, the technical solution provided by the present invention is as follows.

A mobile terminal stand includes a supporting base, a first supporting member, a second supporting member, and a propping component. The propping component is configured for supporting an external device.

The supporting base includes a first bottom member and a second bottom member rotatably connected to the first bottom member. The propping component includes a first propping member and a second propping member rotatably connected to the first propping member. A foot support is provided on the first propping member and/or the second propping member. A bottom portion of the first supporting member is rotatably connected to the first bottom member, a top portion of the first supporting member is rotatably connected to a bottom portion of the second supporting member, and a top portion of the second supporting member is rotatably connected to the first propping member. The first bottom member, the second bottom member, the first propping member, and the second propping member are all in a long strip shape.

When in a storage state, two ends of the first supporting member are respectively close to two ends of the second supporting member, and two ends of the first propping member are respectively close to two ends of the second propping member. The supporting base, the first supporting member, the second supporting member, and the propping component are arranged to be foldable.

When in a use state, two ends of the first bottom member are respectively separated from two ends of the second bottom member, and the two ends of the first propping member are respectively separated from the two ends of the second propping member. The first supporting member and the first bottom member form a first included angle therebetween, and/or the second supporting member and the first propping member form a second included angle therebetween.

Furthermore, the first propping member and the second propping member are both provided with a storage hole, and one end of the foot support is rotatably connected to a side wall of the storage hole.

The foot support is placed in the storage hole when the mobile terminal stand is in the storage state. At least one part of the foot support is placed outside the storage hole when the mobile terminal stand is in the use state.

Furthermore, an outer side wall of the foot support is sleeved with a rubber sleeve. The rubber sleeve is placed inside the storage hole and is in interference fit with the side wall of the storage hole when the mobile terminal stand is in the use state.

Furthermore, one end of the foot support is provided with a first convex block, and a back surface of the first propping member and a back surface of the second propping member are both provided with a first position limiting slot. The first position limiting slot is in communication with the storage hole, and the first convex block is placed in the first position limiting slot when the mobile terminal stand is in the storage state.

Furthermore, the mobile terminal stand further includes a shaft rod. The shaft rod passes through the foot support. Two ends of the shaft rod are respectively placed on two opposite side walls of the storage hole. A first rubber member is provided between the foot support and the shaft rod.

Furthermore, a first extension component is slidably provided at one end of the first propping member away from the foot support. The first extension component is configured for moving in a direction away from the foot support when a volume of the external device is large. A second extension component is slidably provided at one end of the second propping member away from the foot support. The second extension component is configured for moving in a direction away from the foot support when the volume of the external device is large.

Furthermore, the first propping member is provided with a first hole at one end away from the foot support. The first extension component includes a first movable panel, first locking members, and a first sliding block. The first movable panel and at least one part of the first sliding block are respectively positioned above and below the first propping member. One end of the first locking member passes through the first movable panel and the first hole in sequence and then is locked on the first sliding block. A first damping layer is provided between the first movable panel and the first propping member.

Furthermore, the second propping member is provided with a second hole at one end away from the foot support. The second extension component includes a second movable panel, second locking members, and a second sliding block. The second movable panel and at least one part of the second sliding block are respectively positioned above and below the second propping member. One end of the second locking member passes through the second movable panel and the second hole in sequence and then is locked onto the second sliding block. A second damping layer is provided between the second movable panel and the second propping member.

Furthermore, a first accommodating slot is defined in the first propping member, and a depth of the first accommodating slot is consistent with a thickness of the first movable panel. The first movable panel is at least partially placed in the first accommodating slot. A second accommodating slot is defined in the second propping member, and a depth of the second accommodating slot is consistent with a thickness of the second movable panel. The second movable panel is at least partially placed in the second accommodating slot.

A surface of the first propping member and a surface of the second propping member are both provided with first rubber pads, and the first movable panel and the second movable panel are both provided with a second rubber pad. A bottom portion of the first bottom member and a bottom portion of the second bottom member are both equipped with an anti-slip rubber pad.

Furthermore, the mobile terminal stand further includes a first screw. The first screw passes through the first propping member and then is locked to the second propping member. A second rubber member is provided between the first screw and the first propping member. A third damping layer is provided between the first propping member and the second propping member.

Furthermore, the first propping member is provided with a first embedding slot at a position corresponding to the second propping member, and the second propping member is provided with a second embedding slot at a position corresponding to the first propping member. The first propping member is placed in the second embedding slot, and the second propping member is placed in the first embedding slot. A side wall of the first embedding slot is used for limiting a rotation angle of the second propping member, and a side wall of the second embedding slot is used for limiting a rotation angle of the first propping member.

Furthermore, a first connecting seat is rotatably provided on a back surface of the second propping member, and one end of the second supporting member is rotatably connected to the first connecting seat. One end of the first screw passes through the first propping member and the second propping member in sequence and then is locked onto the first connecting seat. The second rubber member is also positioned between the second propping member and the first screw.

Furthermore, a position limiting opening is defined in the first embedding slot, and a second position limiting slot is defined in the second embedding slot. A second convex block is provided on the first connecting seat, and one end of the second convex block passes through the second position limiting slot and then is placed inside the position limiting opening. The position limiting opening and the second position limiting slot are both in a circular arc shape. A fourth damping layer is provided between the second propping member and the first connecting seat.

Furthermore, a back surface of the first connecting seat is provided with a first connecting part, and the mobile terminal stand further includes a first locking component. The first locking component includes a second screw and a first nut. One end of the second screw passes through the first connecting part and the second supporting member and then is locked with the first nut. A fifth damping layer is provided between a screw head of the second screw and the first connecting part. A sixth damping layer is provided between the first connecting part and the second supporting member.

Furthermore, the mobile terminal stand includes a second locking component. The second locking component includes a third screw and a second nut. The third screw passes through the second supporting member and the first supporting member and then is locked with the second nut. Seventh damping layers are provided between the second supporting member and the first supporting member.

Furthermore, a top portion of the first bottom member is provided with a second connecting part, and the mobile terminal stand includes a third locking component. The third locking component includes a fourth screw and a third nut. The fourth screw passes through the first supporting member and the second connecting part and then is locked with the third nut. Eighth damping layers are provided between the first supporting member and the second connecting part.

Furthermore, the first supporting member includes two supporting rods, the second supporting member is at least partially positioned between the two supporting rods, and the second connecting part is at least partially positioned between the two supporting rods. A total number of the seventh damping layers and a total number of the eighth damping layers are both two. The two seventh damping layers are respectively positioned on both sides of the second supporting member, and the two eighth damping layers are respectively positioned on both sides of the second connecting part. One end of the fourth screw passes through one supporting rod, the second connecting part, and the other supporting rod in sequence and then is locked with the third nut. One end of the third screw passes through one supporting rod, the second supporting member, and the other supporting rod in sequence and then is locked with the second nut.

A length of the second supporting member is less than a length of the supporting rod. The second supporting member is completely placed in a gap formed by the two supporting rods when the mobile terminal stand is in the storage state.

Furthermore, the mobile terminal stand further includes a second connecting seat. The second connecting seat is rotatably arranged on a top surface of the first bottom member. A ninth damping layer is provided between the second connecting seat and the first bottom member, and the second connecting part is arranged on a top portion of the second connecting seat. The second connecting seat is configured for rotating the supporting rods through the second connecting part under external force.

Furthermore, the mobile terminal stand further includes a position limiting component. The top surface of the first bottom member is provided with a plurality of fixing slots. The plurality of fixing slots are arranged in an encircling manner. The second connecting seat is provided with a third accommodating slot. The position limiting component includes an elastic member and a rolling ball. The elastic member is at least partially placed in the third accommodating slot, and a bottom portion of the elastic member abuts against the rolling ball. At least one part of the rolling ball is placed in the fixing slot.

The mobile terminal stand further includes a fifth screw and a third rubber member sleeved on the fifth screw. One end of the fifth screw sequentially passes through the second bottom member and the first bottom member and then is locked on the second connecting seat. Part of the third rubber member is positioned between the fifth screw and the first bottom member, and part of the third rubber member is positioned between the fifth screw and the second bottom member. A tenth damping layer is provided between the first bottom member and the second bottom member.

Furthermore, the first bottom member is provided with a third embedding slot at a position corresponding to the second bottom member, and the second bottom member is provided with a fourth embedding slot at a position corresponding to the first bottom member. Part of the first bottom member is placed in the fourth embedding slot, and part of the second bottom member is placed in the third embedding slot. A side wall of the third embedding slot is used for limiting a rotation angle of the second bottom member, and a side wall of the fourth embedding slot is used for limiting a rotation angle of the first bottom member.

Furthermore, a third convex block is provided on the second bottom member, and an arc-shaped third position limiting slot is defined in the third embedding slot. The third convex block is at least partially placed in the third position limiting slot.

Furthermore, the mobile terminal stand further includes a riveting member. The riveting member includes an annular wall, a first annular panel, and a second annular panel. The first annular panel and the second annular panel are respectively connected to both ends of the annular wall.

The annular wall passes through the first bottom member and the second bottom member. Both the first bottom member and the second bottom member are positioned between the first annular panel and the second annular panel. The third rubber member is positioned inside the annular wall.

The present invention has the following beneficial effects. Compared with the prior art, in the present invention, the first bottom member, the second bottom member, the first propping member, and the second propping member are all in a long strip shape. The first bottom member is rotatably connected to the second bottom member. The first propping member is rotatably connected to the second propping member. The two ends of the first supporting member are rotatably connected to the first bottom member and the second supporting member, respectively. The top portion of the second supporting member is rotatably connected to the first propping member. Therefore, the two ends of the first bottom member and the two ends of the second bottom member can be brought together in the storage state and unfolded to form an X shape in the use state, the two ends of the first propping member and the two ends of the second propping member are brought together in the storage state and unfolded to form an X shape in the use state, and the first supporting member forms a first included angle with the first bottom member and/or the second supporting member forms a second included angle with the first propping member. In this way, the mobile terminal stand of this embodiment can be folded when not in use or when carried outside, thereby effectively reducing the overall volume. When in use, the mobile terminal stand can be opened to support the external device. Moreover, by using the foot support, a limit for the external device can be provided to prevent the external device from slipping off the propping component. Furthermore, by adjusting a third included angle between the first supporting member and the second supporting member, adjusting the first included angle between the first supporting member and the first bottom member, and adjusting the second included angle between the second supporting member and the first propping member, a distance between the propping component and the supporting base can be adjusted, so that a height of the external device can be adjusted, thereby providing a user with a comfortable experience of using the external device.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a perspective view of the present invention when unfolded;

FIG. 2 is a perspective view of the present invention when unfolded from another angle of view;

FIG. 3 is an exploded view of a propping component and a foot support of the present invention;

FIG. 4 is an exploded view of a propping component, a first extension component, and a second extension component of the present invention;

FIG. 5 is an exploded view of a propping component, a first connecting seat, and a first screw of the present invention;

FIG. 6 is an exploded view of a propping component, a first connecting seat, and a first screw of the present invention from another angle of view;

FIG. 7 is an exploded view of a first supporting member, a second supporting member, a first connecting seat, a first locking component, a second locking component, and a third locking component of the present invention;

FIG. 8 is an exploded view of a first supporting member, a second supporting member, a first connecting seat, a first locking component, a second locking component, and a third locking component of the present invention from another angle of view;

FIG. 9 is an exploded view of a supporting base and a second connecting seat of the present invention;

FIG. 10 is an exploded view of a supporting base and a second connecting seat of the present invention from another angle of view;

FIG. 11 is a schematic diagram of a folded state of the present invention; and

FIG. 12 is a schematic diagram of a folded state of the present invention from another angle of view.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

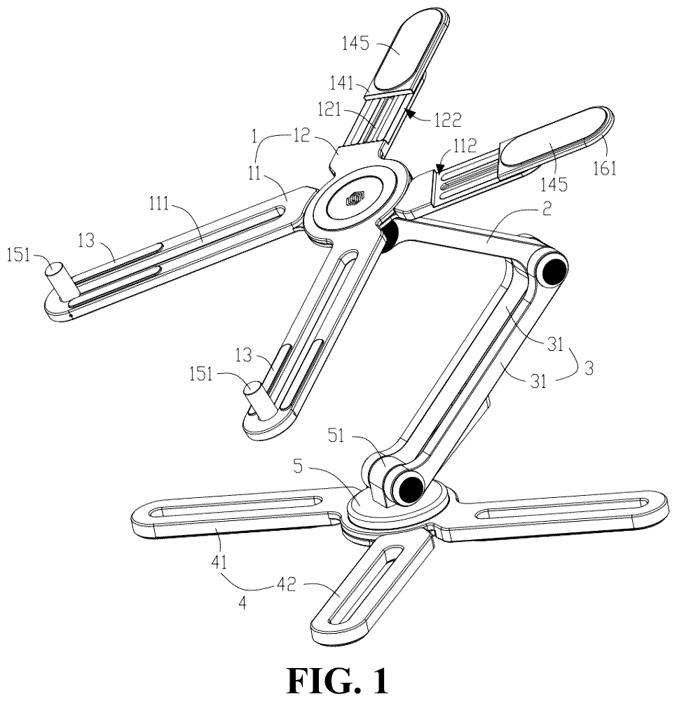

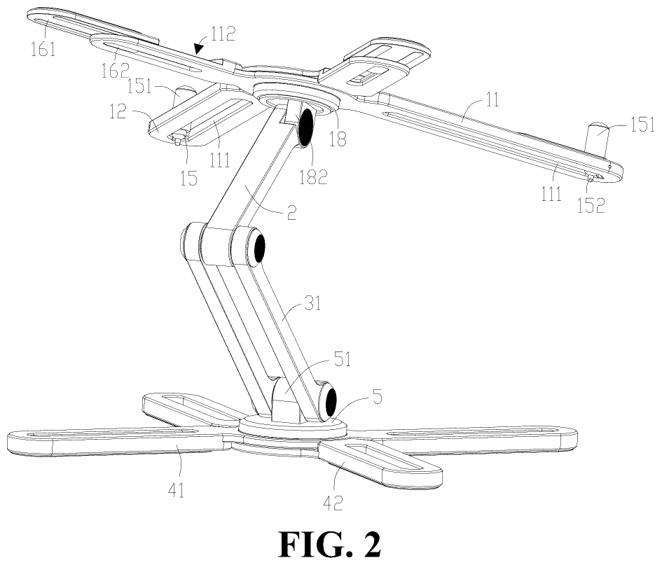

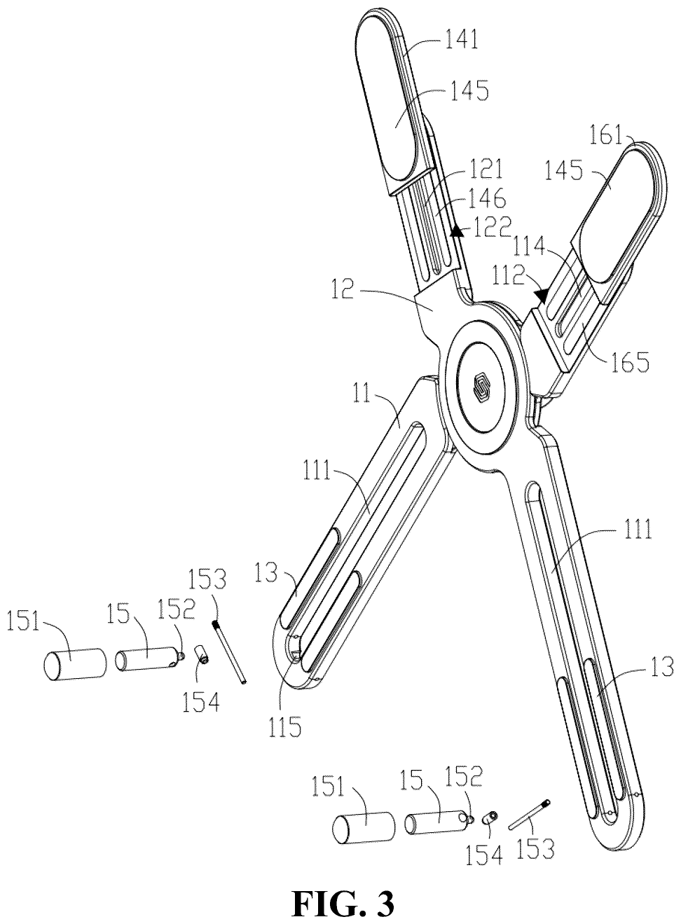

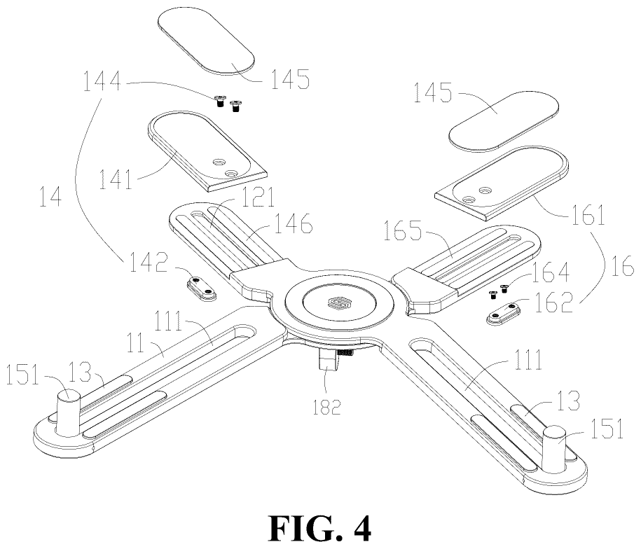

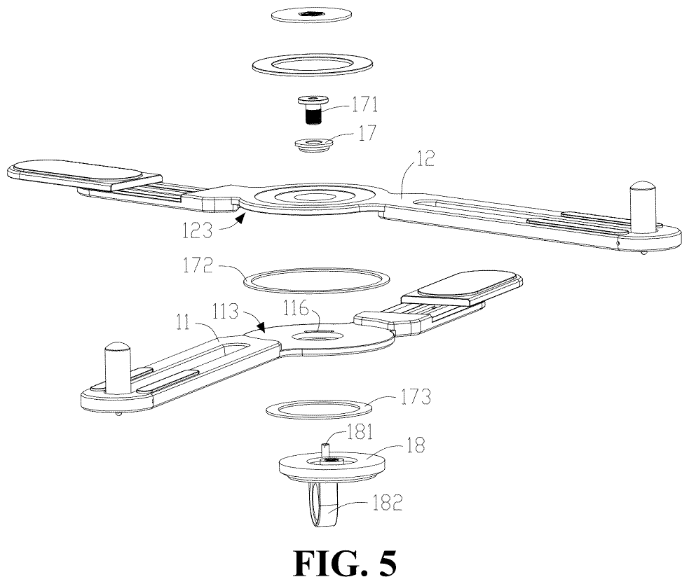

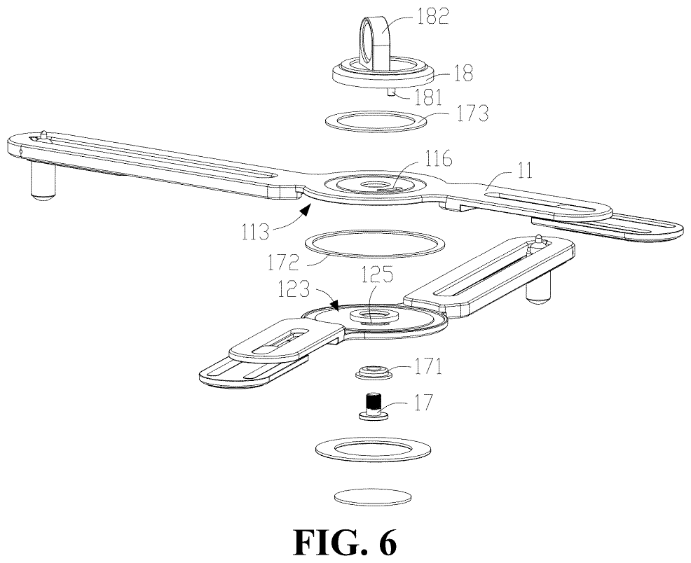

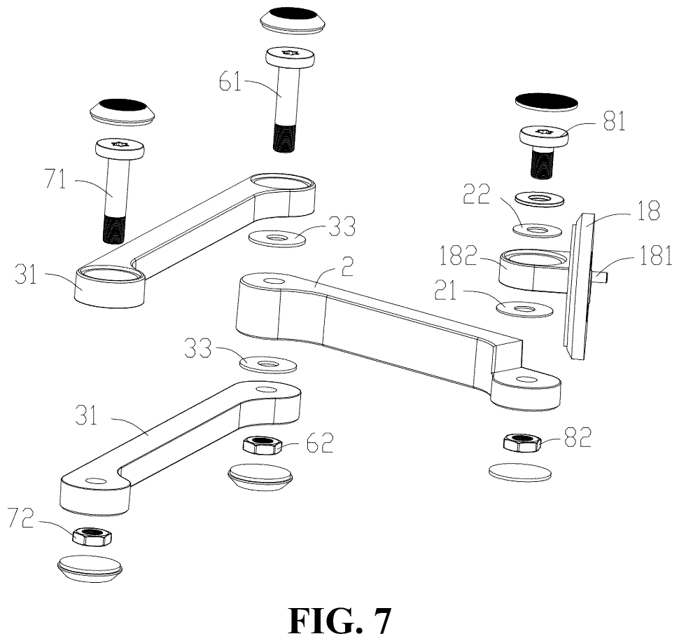

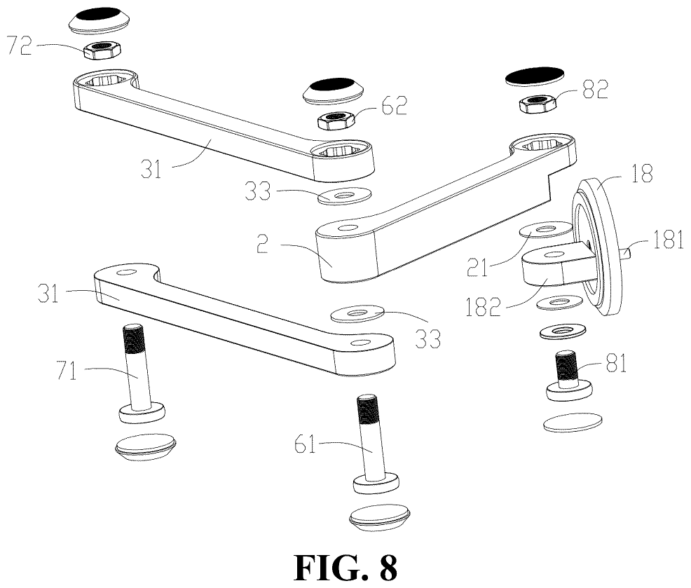

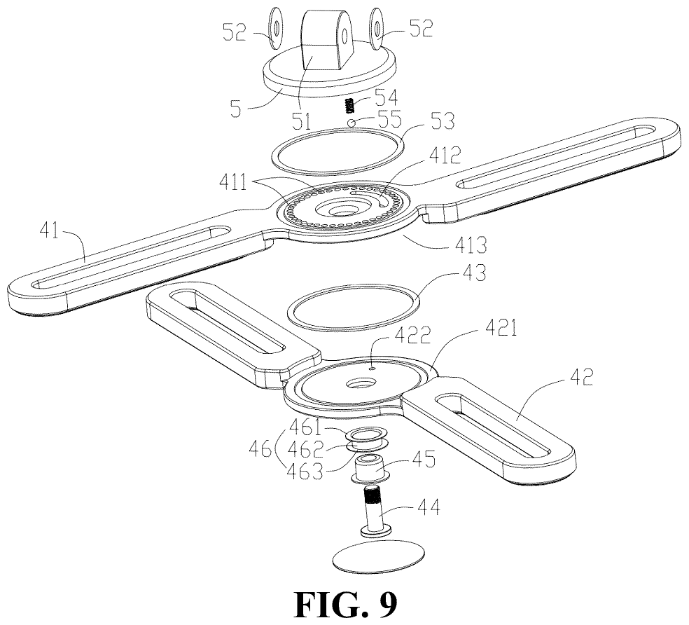

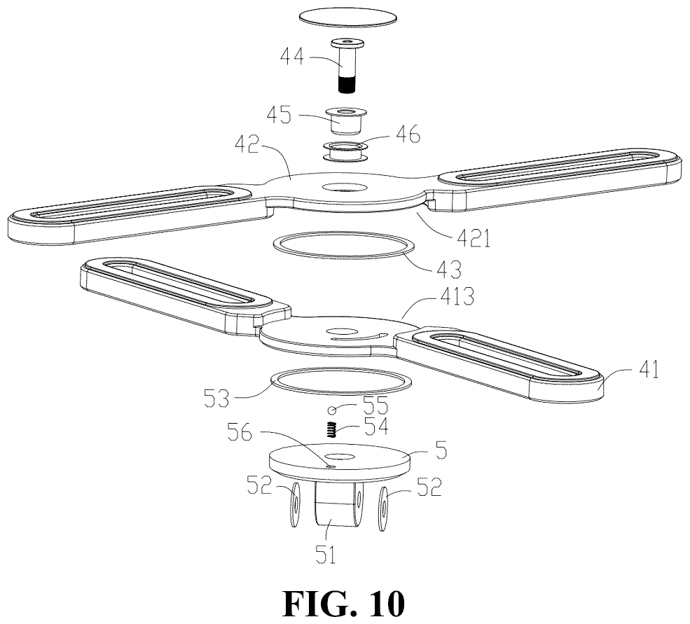

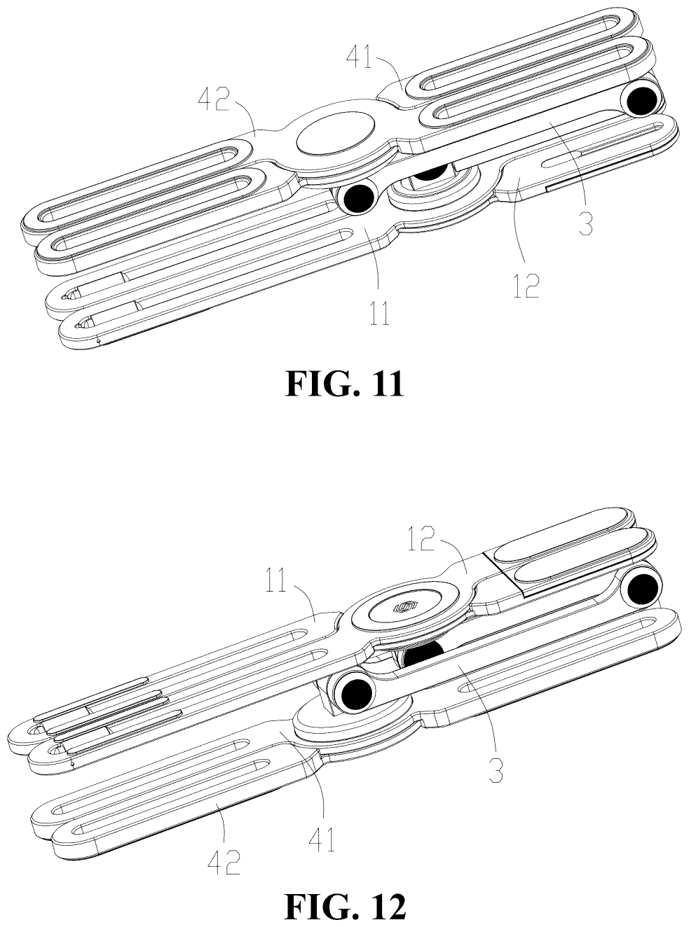

Referring to FIGS. 1-12, a mobile terminal stand is provided in an embodiment of the present invention.

The mobile terminal stand includes a supporting base 4, a first supporting member 3, a second supporting member 2, and a propping component 1. The propping component 1 is configured for supporting an external device. The supporting base 4 includes a first bottom member 41 and a second bottom member 42 rotatably connected to the first bottom member 41. The propping component 1 includes a first propping member 11 and a second propping member 12 rotatably connected to the first propping member 11. A foot support 15 is provided on the first propping member 11 and/or the second propping member 12. A bottom portion of the first supporting member 3 is rotatably connected to the first bottom member 41, a top portion of the first supporting member 3 is rotatably connected to a bottom portion of the second supporting member 2, and a top portion of the second supporting member 2 is rotatably connected to the first propping member 11. The first bottom member 41, the second bottom member 42, the first propping member 11, and the second propping member 12 are all in a long strip shape. When in a storage state, two ends of the first supporting member 3 are respectively close to two ends of the second supporting member 2, and two ends of the first propping member 11 are respectively close to two ends of the second propping member 12. The supporting base 4, the first supporting member 3, the second supporting member 2, and the propping component 1 are arranged to be foldable. When in a use state, two ends of the first bottom member 41 are respectively separated from two ends of the second bottom member 42, the two ends of the first propping member 11 are respectively separated from the two ends of the second propping member 12, and the first supporting member 3 forms a first included angle with the first bottom member 41 and/or the second supporting member 2 forms a second included angle with the first propping member 11, that is, the first bottom member 41 and the second bottom member 42 are arranged in a crossed manner, and the first propping member 11 and the second propping member 12 are arranged in a crossed manner. Both the first included angle and the second included angle are larger than 0.

In this embodiment, the first bottom member 41, the second bottom member 42, the first propping member 11, and the second propping member 12 are all in a long strip shape. The first bottom member 41 is rotatably connected to the second bottom member 42. The first propping member 11 is rotatably connected to the second propping member 12. The two ends of the first supporting member 3 are rotatably connected to the first bottom member 41 and the second supporting member 2, respectively. The top portion of the second supporting member 2 is rotatably connected to the first propping member 11. Therefore, the two ends of the first bottom member 41 and the two ends of the second bottom member 42 can be brought together in the storage state and unfolded to form an X shape in the use state, the two ends of the first propping member 11 and the two ends of the second propping member 12 are brought together in the storage state and unfolded to form an X shape in the use state, and the first supporting member 3 forms the first included angle with the first bottom member 41 and/or the second supporting member 2 forms the second included angle with the first propping member 11. The included angles are larger than 0. In this way, the mobile terminal stand of this embodiment can be folded when not in use or when carried outside, thereby effectively reducing an overall volume. When in use, the mobile terminal stand can be opened to support the external device. Moreover, by using the foot support 15, a limit for the external device can be provided to prevent the external device from slipping off the propping component 1. Furthermore, by adjusting an third included angle between the first supporting member 3 and the second supporting member 2, adjusting the first included angle between the first supporting member 3 and the first bottom member 41, and adjusting the second included angle between the second supporting member 2 and the first propping member 11, a distance between the propping component 1 and the supporting base 4 can be adjusted, so that a height of the external device can be adjusted and a tilt angle of the placement of the external device can be directly adjusted, thereby providing a user with a comfortable experience of using the external device.

Specifically, the external device can be a laptop, a tablet, a mobile phone, etc.

In one embodiment, the foot support 15 can be fixed on the propping component 1 and is immovable.

Of course, in other embodiments, the foot support 15 can also be rotatably arranged on the propping component 1, that is, both the first propping member 11 and the second propping member 12 are rotatably provided with the foot support 15, which is opened to provide support for the external device when the mobile terminal stand in this embodiment is used, and is folded during storage to reduce the volume of the mobile terminal stand.

In the above embodiment, the first propping member 11 and the second propping member 12 are both provided with a storage hole 111, and one end of the foot support 15 is rotatably connected to a side wall of the storage hole 111. The foot support 15 is placed in the storage hole 111 to achieve storage when the mobile terminal stand is in the storage state. At least one part of the foot support 15 is placed outside the storage hole 111 when the mobile terminal stand is in the use state, so as to provide support for the external device during use.

In one embodiment, an outer side wall of the foot support 15 is sleeved with a rubber sleeve 151. The rubber sleeve 151 is placed inside the storage hole 111 and is in interference fit with the side wall of the storage hole 111 when the mobile terminal stand is in the use state, so as to prevent the foot support 15 from opening in the storage state under its own weight and prevent affecting storage.

In one embodiment, one end of the foot support 15 is provided with a first convex block 152, and a back surface of the first propping member 11 and a back surface of the second propping member 12 are both provided with a first position limiting slot 115. The first position limiting slot 115 is in communication with the storage hole 111. The first convex block 152 is placed in the first position limiting slot 115 when the mobile terminal stand is in the storage state. By using the first position limiting slot 115 to limit the first convex block 152, when the user stores the foot support 15 and presses the foot support 15 down, the foot support 15 will not rotate to a back portion of the first propping member 11, thereby improving the user experience during storage.

Specifically, in the above embodiment, the mobile terminal stand further includes a shaft rod 153. The shaft rod 153 passes through the foot support 15. Two ends of the shaft rod 153 are respectively placed on two opposite side walls of the storage hole 111 to achieve the rotational connection between the foot support 15 and the propping component 1.

In one embodiment, a first rubber member 154 is provided between the foot support 15 and the shaft rod 153 to fix the foot support 15 and the shaft rod 153.

In one embodiment, a first extension component 16 is slidably provided at one end of the first propping member 11 away from the foot support 15. The first extension component 16 is configured for moving in a direction away from the foot support 15 when a volume of the external device is large. A second extension component 14 is slidably provided at one end of the second propping member 12 away from the foot support 15. The second extension component 14 is configured for moving in a direction away from the foot support 15 when the volume of the external device is large. When the external device has a large volume, the first extension component 16 can be pulled out in a direction away from the foot support 15 and the second extension component 14 can be pulled out in a direction away from the foot support 15, so that the area supported by the propping component 1 can be increased to adapt to the use of larger tablets, laptops, etc., thereby improving the practicality of the mobile terminal stand in this embodiment. Moreover, when the volume of the external device is small, the first extension component 16 and the second extension component 14 do not need to be unfolded, thereby facilitating the storage of the mobile terminal stand in this embodiment.

Specifically, the first propping member 11 is provided with a first hole 114 at one end away from the foot support 15. The first extension component 16 includes a first movable panel 161, first locking members 164, and a first sliding block 162. The first movable panel 161 and at least one part of the first sliding block 162 are respectively positioned above and below the first propping member 11. One end of the first locking member 164 passes through the first movable panel 161 and the first hole 114 in sequence and then is locked on the first sliding block 162, so as to fix the first movable panel 161 on the first propping member 11. A first damping layer 165 is provided between the first movable panel 161 and the first propping member 11 to increase the friction between the first movable panel 161 and the first propping member 11, achieve fixation of the first movable panel 161 during movement relative to the first propping member 11, and improve the tactile sensation of the movement of the first movable panel 161 relative to the first propping member 11.

The second propping member 12 is provided with a second hole 121 at one end away from the foot support 15. The second extension component 14 includes a second movable panel 141, second locking members 144, and a second sliding block 142. The second movable panel 141 and at least one part of the second sliding block 142 are respectively positioned above and below the second propping member 12. One end of the second locking member 144 passes through the second movable panel 141 and the second hole 121 in sequence and then is locked onto the second sliding block 142, so as to fix the second movable panel 141 to the second propping member 12. A second damping layer 146 is provided between the second movable panel 141 and the second propping member 12, so as to increase the friction between the second movable panel 141 and the second propping member 12, achieve fixation of the second movable panel 141 during movement relative to the second propping member 12, and improve the tactile sensation of the movement of the second movable panel 141 relative to the second propping member 12.

In one embodiment, a first accommodating slot 112 is defined in the first propping member 11, and a depth of the first accommodating slot 112 is consistent with a thickness of the first movable panel 161. The first movable panel 161 is at least partially placed in the first accommodating slot 112, so that a surface of the first movable panel 161 and a surface of the first propping member 11 are in an identical plane. A second accommodating slot 122 is defined in the second propping member 12, and a depth of the second accommodating slot 122 is consistent with a thickness of the second movable panel 141. The second movable panel 141 is at least partially placed in the second accommodating slot 122, so that a surface of the second movable panel 141 and a surface of the second propping member 12 are on an identical plane, and the external device can be smoothly placed on the propping component 1.

In the above embodiment, a surface of the first propping member 11 and a surface of the second propping member 12 are both provided with first rubber pads 13, and the first movable panel 161 and the second movable panel 141 are both provided with a second rubber pad 145. By using the first rubber pad 13 and the second rubber pad 145, the friction between the external device and the propping component 1 can be increased, thereby preventing the external device from slipping off the propping component 1. Moreover, the first rubber pad 13 and the second rubber pad 145 can prevent scratches between the external device and the propping component 1, playing a buffering role. A bottom portion of the first bottom member 41 and a bottom portion of the second bottom member 42 are both equipped with an anti-slip rubber pad. By using the anti-slip rubber pad, the friction between the supporting base 4 and a placing surface can be increased, making the placement of the mobile terminal stand in this embodiment more stable.

In the above embodiment, the mobile terminal stand further includes a first screw 171. The first screw 171 passes through the first propping member 11 and then is locked to the second propping member 12. A second rubber member 17 is provided between the first screw 171 and the first propping member 11 to achieve rotational connection between the first propping member 11 and the second propping member 12. A third damping layer 172 is provided between the first propping member 11 and the second propping member 12. By using the third damping layer 172, the first propping member 11 and the second propping member 12 can be fixed when they rotate relative to each other, increasing the tactile sensation of the relative rotation between the first propping member 11 and the second propping member 12 for user convenience.

In one embodiment, the first propping member 11 is provided with a first embedding slot 113 at a position corresponding to the second propping member 12, and the second propping member 12 is provided with a second embedding slot 123 at a position corresponding to the first propping member 11. The first propping member 11 is placed in the second embedding slot 123, and the second propping member 12 is placed in the first embedding slot 113. A side wall of the first embedding slot 113 is used for limiting a rotation angle of the second propping member 12, and a side wall of the second embedding slot 123 is used for limiting a rotation angle of the first propping member 11. Moreover, by using the first embedding slot 113 and the second embedding slot 123, a surface of the first propping member 11 and a surface of the second propping member 12 can be placed on an identical plane, thereby facilitating the placement of the external device.

In one embodiment, a first connecting seat 18 is rotatably provided on a back surface of the second propping member 12, and one end of the second supporting member 2 is rotatably connected to the first connecting seat 18 to achieve the rotational connection between the second propping member 12 and the second supporting member 2. One end of the first screw 171 passes through the first propping member 11 and the second propping member 12 in sequence and then is locked onto the first connecting seat 18. The second rubber member 17 is also positioned between the second propping member 12 and the first screw 171.

A position limiting opening 116 is defined in the first embedding slot 113, and a second position limiting slot 125 is defined in the second embedding slot 123. A second convex block 181 is provided on the first connecting seat 18, and one end of the second convex block 181 passes through the second position limiting slot 125 and then is placed inside the position limiting opening 116. The position limiting opening 116 and the second position limiting slot 125 are both in a circular arc shape. A fourth damping layer 173 is provided between the second propping member 12 and the first connecting seat 18. By using the second convex block 181 to cooperate with the position limiting opening 116 and the second position limiting slot 125, the rotation between the first propping member 11 and the second propping member 12 can be more stable. By utilizing the fourth damping layer 173, the friction between the second propping member 12 and the first connecting seat 18 can be increased, achieving fixation during relative rotation between the second propping member 12 and the first connecting seat 18, so that the user can adjust a rotation angle between the first connecting seat 18 and the second propping member 12, increasing the tactile sensation of rotation between the first connecting seat 18 and the second propping member 12.

In one embodiment, a back surface of the first connecting seat 18 is provided with a first connecting part 182, and the mobile terminal stand further includes a first locking component. The first locking component includes a second screw 81 and a first nut 82. One end of the second screw 81 passes through the first connecting part 182 and the second supporting member 2 and then is locked with the first nut 82, so as to achieve the rotational connection between the first connecting part 182 and a top portion of the second supporting member 2. A fifth damping layer 22 is provided between a screw head of the second screw 81 and the first connecting part 182 to limit the relative position between the second screw 81 and the first connecting part 182. A sixth damping layer 21 is provided between the first connecting part 182 and the second supporting member 2 to increase the friction between the first connecting part 182 and the second supporting member 2, achieve fixation during relative rotation between the first connecting part 182 and the second supporting member 2, so that the user can adjust a rotation angle between the first connecting part 182 and the second supporting member 2, and increase the tactile sensation of rotation between the first connecting part 182 and the second supporting member 2.

In one embodiment, the mobile terminal stand includes a second locking component. The second locking component includes a third screw 61 and a second nut 62. The third screw 61 passes through the second supporting member 2 and the first supporting member 3 and then is locked with the second nut 62. Seventh damping layers 33 are provided between the second supporting member 2 and the first supporting member 3, so as to achieve rotational connection between the second supporting member 2 and the first supporting member 3. Moreover, by using the seventh damping layers 33, the second supporting member 2 and the first supporting member 3 can be fixed when they rotate relative to each other, so that the user can adjust a rotation angle between the second supporting member 2 and the first supporting member 3, and increase the tactile sensation of rotation between the second supporting member 2 and the first supporting member 3.

In one embodiment, a top portion of the first bottom member 41 is provided with a second connecting part 51, and the mobile terminal stand includes a third locking component. The third locking component includes a fourth screw 71 and a third nut 72. The fourth screw 71 passes through the first supporting member 3 and the second connecting part 51 and then is locked with the third nut 72. Eighth damping layers 52 are provided between the first supporting member 3 and the second connecting part 51, so as to achieve the rotational connection between the first supporting member 3 and the second connecting part 51. Moreover, by using the eighth damping layers 52, the second connecting part 51 and the first supporting member 3 can be fixed when they rotate relative to each other, so that the user can adjust a rotation angle between the second connecting part 51 and the first supporting member 3, increasing the tactile sensation of rotation between the second connecting part 51 and the first supporting member 3.

In one embodiment, in order to improve the supporting stability of the first supporting member 3, the first supporting member 3 includes two supporting rods 31, the second supporting member 2 is at least partially positioned between the two supporting rods 31, and the second connecting part 51 is at least partially positioned between the two supporting rods 31. A total number of the seventh damping layers 33 and a total number of the eighth damping layers 52 are both two. The two seventh damping layers 33 are respectively positioned on both sides of the second supporting member 2, and the two eighth damping layers 52 are respectively positioned on both sides of the second connecting part 51. One end of the fourth screw 71 passes through one supporting rod 31, the second connecting part 51, and the other supporting rod 31 in sequence and then is locked with the third nut 72. One end of the third screw 61 passes through one supporting rod 31, the second supporting member 2, and the other supporting rod 31 in sequence and then is locked with the second nut 62.

In one embodiment, a length of the second supporting member 2 is less than a length of the supporting rod 31. The second supporting member 2 is completely placed in a gap formed by the two supporting rods 31 when the mobile terminal stand is in the storage state, which can reduce the volume of the mobile terminal stand in the storage state and facilitate the user's storage and carrying.

In one embodiment, the mobile terminal stand further includes a second connecting seat 5. The second connecting seat 5 is rotatably arranged on a top surface of the first bottom member 41. A ninth damping layer 53 is provided between the second connecting seat 5 and the first bottom member 41, and the second connecting part 51 is arranged on a top portion of the second connecting seat 5. The second connecting seat 5 is configured for rotating the supporting rods 31 and the second supporting member 2 through the second connecting part 51 under external force, so that when a tablet or computer is placed on the propping component 1,360-degree rotation is achieved, a function of horizontal rotation is increased, the practicality is improved, thereby enabling the user to adjust direction for use.

In one embodiment, the mobile terminal stand further includes a position limiting component. The top surface of the first bottom member 41 is provided with a plurality of fixing slots 411. The plurality of fixing slots 411 are arranged in an encircling manner. A side wall of each fixing slot 411 is an inclined surface or a cambered surface. The second connecting seat 5 is provided with a third accommodating slot 56. The position limiting component includes an elastic member 54 and a rolling ball 55. The elastic member 54 is at least partially placed in the third accommodating slot 56, and a bottom portion of the elastic member 54 abuts against the rolling ball 55. At least one part of the rolling ball 55 is placed in the fixing slot 411. By using the elastic member 54 to apply a downward force to the rolling ball 55, the friction between the second connecting seat 5 and the first bottom member 41 can be increased, achieving the positioning of the relative rotation between the second connecting seat 5 and the first bottom member 41. Moreover, when the second connecting seat 5 and the first bottom member 41 rotate relative to each other, a “click” sound can be emitted, which can relieve the pressure.

Specifically, the elastic member 54 can be a spring, an elastic sheet, or the like.

In one embodiment, the mobile terminal stand further includes a fifth screw 44 and a third rubber member 45 sleeved on the fifth screw 44. One end of the fifth screw 44 sequentially passes through the second bottom member 42 and the first bottom member 41 and then is locked on the second connecting seat 5. Part of the third rubber member 45 is positioned between the fifth screw 44 and the first bottom member 41, and part of the third rubber member 45 is positioned between the fifth screw 44 and the second bottom member 42. A tenth damping layer 43 is provided between the first bottom member 41 and the second bottom member 42. In this way, the first bottom member 41 and the second bottom member 42 are rotatably connected, and by using the tenth damping layer 43, the first bottom member 41 and the second bottom member 42 can be positioned after their relative rotation, so as to adjust the angle of relative rotation between the first bottom member 41 and the second bottom member 42, and increase the tactile sensation of relative rotation between the first bottom member 41 and the second bottom member 42.

In one embodiment, the first bottom member 41 is provided with a third embedding slot 413 at a position corresponding to the second bottom member 42, and the second bottom member 42 is provided with a fourth embedding slot 421 at a position corresponding to the first bottom member 41. Part of the first bottom member 41 is placed in the fourth embedding slot 421, and part of the second bottom member 42 is placed in the third embedding slot 413. A side wall of the third embedding slot 413 is used for limiting a rotation angle of the second bottom member 42, and a side wall of the fourth embedding slot 421 is used for limiting a rotation angle of the first bottom member 41. Moreover, by using the third embedding slot 413 and the fourth embedding slot 421, a bottom surface of the first bottom member 41 and a bottom surface of the second bottom member 42 can be placed on an identical plane, so as to smoothly place the mobile terminal stand on the placing surface.

In one embodiment, a third convex block 422 is provided on the second bottom member 42, and an arc-shaped third position limiting slot 412 is defined in the third embedding slot 413. The third convex block 422 is at least partially placed in the third position limiting slot 412 to limit an angle of opening between the first bottom member 41 and the second bottom member 42.

In one embodiment, the mobile terminal stand further includes a riveting member 46. The riveting member 46 includes an annular wall 462, a first annular panel 461, and a second annular panel 463. The first annular panel 461 and the second annular panel 463 are respectively connected to both ends of the annular wall 462. The annular wall 462 passes through the first bottom member 41 and the second bottom member 42. Both the first bottom member 41 and the second bottom member 42 are positioned between the first annular panel 461 and the second annular panel 463. The third rubber member 45 is positioned inside the annular wall 462 to improve the firmness of the rotational connection between the first bottom member 41 and the second bottom member 42.

In the above embodiments, the first damping layer 165, the second damping layer 146, the third damping layer 172, the fourth damping layer 173, the fifth damping layer 22, the sixth damping layer 21, the seventh damping layer 33, the eighth damping layer 52, the ninth damping layer 53, and the tenth damping layer 43 can all be nylon gaskets. The first bottom member 41, the second bottom member 42, the supporting rod 31, the first propping member 11, the second supporting member 2, and the second propping member 12 are all made of metal materials, with aluminum alloy being preferred for heat dissipation of external devices such as tablets and computers.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. A mobile terminal stand, comprising a supporting base, a first supporting member, a second supporting member, and a propping component; wherein the propping component is configured for supporting an external device;
the supporting base comprises a first bottom member and a second bottom member rotatably connected to the first bottom member, the propping component comprises a first propping member and a second propping member rotatably connected to the first propping member, a foot support is provided on the first propping member and/or the second propping member, a bottom portion of the first supporting member is rotatably connected to the first bottom member, a top portion of the first supporting member is rotatably connected to a bottom portion of the second supporting member, and a top portion of the second supporting member is rotatably connected to the first propping member; the first bottom member, the second bottom member, the first propping member, and the second propping member are all in a long strip shape;
when in a storage state, two ends of the first supporting member are respectively close to two ends of the second supporting member, and two ends of the first propping member are respectively close to two ends of the second propping member; the supporting base, the first supporting member, the second supporting member, and the propping component are arranged to be foldable;
when in a use state, two ends of the first bottom member are respectively separated from two ends of the second bottom member, and the two ends of the first propping member are respectively separated from the two ends of the second propping member; the first supporting member and the first bottom member form a first included angle therebetween, and/or the second supporting member and the first propping member form a second included angle therebetween.

2. The mobile terminal stand according to claim 1, wherein the first propping member and the second propping member are both provided with a storage hole, and one end of the foot support is rotatably connected to a side wall of the storage hole;
the foot support is placed in the storage hole when the mobile terminal stand is in the storage state, and at least one part of the foot support is placed outside the storage hole when the mobile terminal stand is in the use state.

3. The mobile terminal stand according to claim 2, wherein an outer side wall of the foot support is sleeved with a rubber sleeve, and the rubber sleeve is placed inside the storage hole and is in interference fit with the side wall of the storage hole when the mobile terminal stand is in the use state.

4. The mobile terminal stand according to claim 3, wherein one end of the foot support is provided with a first convex block, a back surface of the first propping member and a back surface of the second propping member are both provided with a first position limiting slot, the first position limiting slot is in communication with the storage hole, and the first convex block is placed in the first position limiting slot when the mobile terminal stand is in the storage state.

5. The mobile terminal stand according to claim 4, wherein the mobile terminal stand further comprises a shaft rod, the shaft rod passes through the foot support, two ends of the shaft rod are respectively placed on two opposite side walls of the storage hole, and a first rubber member is provided between the foot support and the shaft rod.

6. The mobile terminal stand according to claim 1, wherein a first extension component is slidably provided at one end of the first propping member away from the foot support, and the first extension component is configured for moving in a direction away from the foot support when a volume of the external device is large; a second extension component is slidably provided at one end of the second propping member away from the foot support, the second extension component is configured for moving in a direction away from the foot support when the volume of the external device is large.

7. The mobile terminal stand according to claim 6, wherein the first propping member is provided with a first hole at one end away from the foot support; the first extension component comprises a first movable panel, first locking members, and a first sliding block; the first movable panel and at least one part of the first sliding block are respectively positioned above and below the first propping member, one end of the first locking member passes through the first movable panel and the first hole in sequence and then is locked on the first sliding block, and a first damping layer is provided between the first movable panel and the first propping member;
the second propping member is provided with a second hole at one end away from the foot support; the second extension component comprises a second movable panel, second locking members, and a second sliding block; the second movable panel and at least one part of the second sliding block are respectively positioned above and below the second propping member, one end of the second locking member passes through the second movable panel and the second hole in sequence and then is locked onto the second sliding block, and a second damping layer is provided between the second movable panel and the second propping member.

8. The mobile terminal stand according to claim 7, wherein a first accommodating slot is defined in the first propping member, a depth of the first accommodating slot is consistent with a thickness of the first movable panel, and the first movable panel is at least partially placed in the first accommodating slot; a second accommodating slot is defined in the second propping member, a depth of the second accommodating slot is consistent with a thickness of the second movable panel, and the second movable panel is at least partially placed in the second accommodating slot;
a surface of the first propping member and a surface of the second propping member are both provided with first rubber pads, the first movable panel and the second movable panel are both provided with a second rubber pad, and a bottom portion of the first bottom member and a bottom portion of the second bottom member are both equipped with an anti-slip rubber pad.

9. The mobile terminal stand according to claim 1, wherein the mobile terminal stand further comprises a first screw, the first screw passes through the first propping member and then is locked to the second propping member, a second rubber member is provided between the first screw and the first propping member, and a third damping layer is provided between the first propping member and the second propping member.

10. The mobile terminal stand according to claim 9, wherein the first propping member is provided with a first embedding slot at a position corresponding to the second propping member, the second propping member is provided with a second embedding slot at a position corresponding to the first propping member, the first propping member is placed in the second embedding slot, the second propping member is placed in the first embedding slot, a side wall of the first embedding slot is used for limiting a rotation angle of the second propping member, and a side wall of the second embedding slot is used for limiting a rotation angle of the first propping member.

11. The mobile terminal stand according to claim 10, wherein a first connecting seat is rotatably provided on a back surface of the second propping member, and one end of the second supporting member is rotatably connected to the first connecting seat; one end of the first screw passes through the first propping member and the second propping member in sequence and then is locked onto the first connecting seat, and the second rubber member is also positioned between the second propping member and the first screw;
a position limiting opening is defined in the first embedding slot, a second position limiting slot is defined in the second embedding slot, a second convex block is provided on the first connecting seat, one end of the second convex block passes through the second position limiting slot and then is placed inside the position limiting opening, the position limiting opening and the second position limiting slot are both in a circular arc shape, and a fourth damping layer is provided between the second propping member and the first connecting seat.

12. The mobile terminal stand according to claim 11, wherein a back surface of the first connecting seat is provided with a first connecting part, the mobile terminal stand further comprises a first locking component, the first locking component comprises a second screw and a first nut, one end of the second screw passes through the first connecting part and the second supporting member and then is locked with the first nut, a fifth damping layer is provided between a screw head of the second screw and the first connecting part, and a sixth damping layer is provided between the first connecting part and the second supporting member.

13. The mobile terminal stand according to claim 1, wherein the mobile terminal stand comprises a second locking component, the second locking component comprises a third screw and a second nut, the third screw passes through the second supporting member and the first supporting member and then is locked with the second nut, and seventh damping layers are provided between the second supporting member and the first supporting member.

14. The mobile terminal stand according to claim 13, wherein a top portion of the first bottom member is provided with a second connecting part, the mobile terminal stand comprises a third locking component, the third locking component comprises a fourth screw and a third nut, the fourth screw passes through the first supporting member and the second connecting part and then is locked with the third nut, and eighth damping layers are provided between the first supporting member and the second connecting part.

15. The mobile terminal stand according to claim 14, wherein the first supporting member comprises two supporting rods, the second supporting member is at least partially positioned between the two supporting rods, and the second connecting part is at least partially positioned between the two supporting rods; a total number of the seventh damping layers and a total number of the eighth damping layers are both two, the two seventh damping layers are respectively positioned on both sides of the second supporting member, and the two eighth damping layers are respectively positioned on both sides of the second connecting part; one end of the fourth screw passes through one supporting rod, the second connecting part, and the other supporting rod in sequence and then is locked with the third nut; one end of the third screw passes through one supporting rod, the second supporting member, and the other supporting rod in sequence and then is locked with the second nut;
a length of the second supporting member is less than a length of the supporting rod, and the second supporting member is completely placed in a gap formed by the two supporting rods when the mobile terminal stand is in the storage state.

16. The mobile terminal stand according to claim 14, wherein the mobile terminal stand further comprises a second connecting seat, the second connecting seat is rotatably arranged on a top surface of the first bottom member, a ninth damping layer is provided between the second connecting seat and the first bottom member, the second connecting part is arranged on a top portion of the second connecting seat, and the second connecting seat is configured for rotating the supporting rods through the second connecting part under external force.

17. The mobile terminal stand according to claim 16, wherein the mobile terminal stand further comprises a position limiting component, the top surface of the first bottom member is provided with a plurality of fixing slots, the plurality of fixing slots are arranged in an encircling manner, the second connecting seat is provided with a third accommodating slot, the position limiting component comprises an elastic member and a rolling ball, the elastic member is at least partially placed in the third accommodating slot, a bottom portion of the elastic member abuts against the rolling ball, and at least one part of the rolling ball is placed in the fixing slot;
the mobile terminal stand further comprises a fifth screw and a third rubber member sleeved on the fifth screw, one end of the fifth screw sequentially passes through the second bottom member and the first bottom member and then is locked on the second connecting seat, part of the third rubber member is positioned between the fifth screw and the first bottom member, part of the third rubber member is positioned between the fifth screw and the second bottom member, and a tenth damping layer is provided between the first bottom member and the second bottom member.

18. The mobile terminal stand according to claim 17, wherein the first bottom member is provided with a third embedding slot at a position corresponding to the second bottom member,
the second bottom member is provided with a fourth embedding slot at a position corresponding to the first bottom member, part of the first bottom member is placed in the fourth embedding slot, part of the second bottom member is placed in the third embedding slot, a side wall of the third embedding slot is used for limiting a rotation angle of the second bottom member, and a side wall of the fourth embedding slot is used for limiting a rotation angle of the first bottom member.

19. The mobile terminal stand according to claim 18, wherein a third convex block is provided on the second bottom member, an arc-shaped third position limiting slot is defined in the third embedding slot, and the third convex block is at least partially placed in the third position limiting slot.

20. The mobile terminal stand according to claim 18, wherein the mobile terminal stand further comprises a riveting member; the riveting member comprises an annular wall, a first annular panel, and a second annular panel; the first annular panel and the second annular panel are respectively connected to both ends of the annular wall;
the annular wall passes through the first bottom member and the second bottom member, both the first bottom member and the second bottom member are positioned between the first annular panel and the second annular panel, and the third rubber member is positioned inside the annular wall.
